(19) United States
(12) Patent Application Publication
(10) Pub. No.: US 2007/0289791 A1
(43) Pub. Date: Dec. 20, 2007

(54) Sideloader with improved visual operability

(76) Inventor: Manfred Kaufmann, Elburn, IL (US)

Correspondence Address: THE LAW OFFICE OF RANDALL T. ERICKSON, P.C., 1749 S. NAPERVILLE ROAD, SUITE 202, WHEATON, IL, 60187, US

(21) Appl. No.: 11/454,238

(22) Filed: Jun. 17, 2006

(51) Int. Cl. B62D 31/00

(52) U.S. Cl. 180/89.1

(57) ABSTRACT

A sideloader forklift vehicle has a chassis supported on a plurality of wheels, a forklift mechanism supported on the chassis, an operator's cab supported on the chassis, and a battery cabinet supported on the chassis for electrically powering the sideloader forklift vehicle. The battery cabinet is elongated along a line parallel to the cab side edge of the chassis and has a cab side face located at a distance from the cab side edge whereby an operator within the operator's cab has a clear line of vision to a corner of the chassis defined by the cab side edge and the front end edge of the chassis. A side cabinet is provided between the cab side face of the battery cabinet and the cab side edge of the chassis, tapered in height from the cab to the front end edge of the vehicle chassis.

### TECHNICAL FIELD OF THE INVENTION

This invention relates to a forklift vehicle. Particularly, this invention is directed to such a sideloader forklift vehicle having an electric motor drive.

### BACKGROUND OF THE INVENTION

In some warehouse operations, a sideloader forklift vehicle capable of maneuvering along and within a narrow aisle is used to retrieve and deposit loads, usually on multi-tier racks.

An example of such a lift truck is a BAUMANN® ElectricFourway-Sideloader Series EVU 20/25/30 available from Baumann Handling Systems, Inc., of Yorkville, Ill., USA. U.S. Pat. No. 3,067,839 also describes a sideloader vehicle, herein incorporated by reference.

A typical prior art electric sideloader forklift vehicle 20 is illustrated schematically in FIGS. 1-3. The sideloader includes four wheels 22, 24, 26, 28 that support a prone U-shaped chassis 32 from a floor surface. The chassis includes a longitudinally extended base 33 and laterally extended legs 34, 35. The chassis 32 supports a hydraulic forklift assembly 36.

For purposes of orientation of the description herein, the chassis 32 has a front end 42 having a front end edge 42a, a rear end 44 having a rear end edge 44a, a rack side 46 having a rack side edge 46a, and a cab side 48 having a cab side edge 48a. The rack side 46 is the side which must approach a rack for loading and unloading articles passing across the rack side edge 46a using the forklift assembly 36. A cab 52 is arranged on the base 33 along the cab side edge and along the rear end edge. Batteries 56 are arranged within a cabinet 57 arranged on the base 33 along the cab side 48 adjacent to the cab 52. An end cabinet 58 for containing the electronics and hydraulics is provided adjacent to the batteries, along the cab side 48 and along the front end 42.

The cab side wheels 22, 24 are driven by motors 59, 60. The cab side wheels are driven and steerable wheels such as described in U.S. Pat. No. 3,163,250.

The forklift assembly 36 includes a frame-like mast 64 that supports a fork 66 having a longitudinally extended cross beam 67 and two laterally extended tines 68, 70 extending from the cross beam 67. The cross beam 67 is guided for vertical movement on the mast 64 and supported vertically by a hydraulic cylinder 76 connected to the mast. The hydraulic cylinder 76 is used to selectively raise-and-lower the fork 66. The fork 66 is shown supporting a load 78 being loaded onto, or unloaded from, a rack 82. In this regard, the mast 64 is guided for horizontal translation on the chassis 32 by rollers (not shown) that move in guide tracks 90, 92 arranged in the legs 35, 36 of the chassis 32. The mast is translated horizontally toward and away from the edge 46a by one or more hydraulic cylinders (not shown).

In typical electric driven sideloader forklift vehicles, the batteries are located along the cab side of the sideloader forklift vehicle in order to make the sideloader forklift vehicle as narrow as possible to fit in narrow aisles laid out to effectively maximize warehouse storage space. For the same reasons, the cab is kept small, in many instances only allowing for a stand-up cab. Room for electric components, electronics, a hydraulic tank and the drive motor 60 is created at the opposite end of the cab, within the end cabinet 58.

The present inventor has recognized that this end location of the cabinet 58 blocks the batteries from being longitudinally slid out for replacement, which is preferred, and limits the battery changing process to a lift-out design. Also, the present inventor has recognized that the weight and relative high center of gravity of the batteries along the cab side of the truck makes this design more likely to tip over if the truck is turned too aggressively.

In a typical loading operation in a warehouse, the forklift assembly of the sideloader forklift vehicle holds a large stack of elongated articles, such as lumber, which effectively blocks the operator's view of the rack on the rack side of the sideloader forklift vehicle. The operator must estimate the position of the sideloader forklift vehicle with respect to the rack by observing the position of the cab side of the sideloader forklift vehicle with respect to markings on the floor or external structures. When moving the vehicle within narrow aisles of a warehouse it is considered safe practice for the operator to keep his head within the cab. The present inventor has recognized that by keeping his head within the cab, it is difficult for an operator to estimate the precise position of the chassis given that the batteries are aligned longitudinally with the cab and due to the height of the batteries, the battery cabinet presents an obstacle to the operator viewing the location of the front lower edge of the chassis.

### SUMMARY OF THE INVENTION

The invention provides an forklift apparatus with an improved visual operability, improved safety features, improved stability and an improved operator's comfort.

According to one aspect of the invention, a forklift vehicle comprises a chassis, a plurality of wheels, a forklift mechanism, an operator's cab, and an equipment cabinet. The chassis defines a rack side edge, a cab side edge opposite to the rack side edge, a front end edge, and a rear end edge opposite to the front end edge. The plurality of wheels supports the chassis from a ground surface. The forklift mechanism is oriented to load and unload elongated articles across the rack side edge of the forklift vehicle. The operator's cab is located along the cab side edge and the rear end edge of the forklift vehicle. The equipment cabinet is located along the cab side edge, the equipment cabinet having a tapered height from the operator's cab toward the front end edge, whereby an operator within the operator's cab has a clear line of vision to a corner of the chassis defined by the cab side edge and the front end edge.

Preferably, the equipment cabinet extends from the operator's cab to the front end edge, the height of the equipment cabinet being linearly tapered from the operator's cab to the front end edge. Preferably, the equipment cabinet houses electronic and hydraulic components of the apparatus.

According to another aspect of the invention, an electrically powered sideloader forklift vehicle has a chassis supported on a plurality of wheels, a forklift mechanism supported on the chassis, an operator's cab supported on the chassis, one or more electric motors driving one or more wheels, and one or more batteries supported on the chassis for electrically powering the electric motor or motors. The chassis defines a rack side edge, a cab side edge opposite to the rack side edge, a front end edge, and a rear end edge opposite to the front end edge. The operator's cab is located along the cab side edge and the rear end edge of the sideloader forklift vehicle. The batteries are arranged along a line parallel to the cab side edge, preferably within a battery cabinet, with a cab side face or sidewall located at a distance from the cab side edge whereby an operator within the operator's cab has a clear line of vision to a corner of the chassis defined by the cab side edge and the front end edge.

An equipment cabinet can be located on the chassis between the cab side edge and the cab side face of the battery cabinet, the equipment cabinet having a tapered height from the operator's cab that end edge. The equipment cabinet can house electronic and hydraulic components of the apparatus.

The equipment cabinet can extend from the operator's cab to the front end edge, the height of the equipment cabinet being linearly tapered from the operator's cab to the front end edge.

Advantageously, only one electric drive motor can be used to drive one of the plurality of wheels and a distinct steering driver is operatively connected to each wheel of the plurality of wheels.

Numerous other advantages and features of the present invention will be become readily apparent from the following detailed description of the invention and the embodiments thereof, and from the accompanying drawings.

### BRIEF DESCRIPTION OF THE DRAWINGS

FIG. 1 is a schematic perspective view of a prior art sideloader forklift vehicle delivering a load of elongated articles onto a rack;

FIG. 2 is a schematic top plan view of the sideloader forklift vehicle shown in FIG. 1;

FIG. 3 is a schematic side elevation view of the sideloader forklift vehicle shown in FIG. 1;

FIG. 4 is a schematic top plan view of a sideloader forklift vehicle of the present invention;

FIG. 5 is a schematic side elevation view of the sideloader forklift vehicle shown in FIG. 4;

FIG. 6 is a schematic plan view of a steering system of the sideloader forklift vehicle shown in FIG. 4;

FIG. 7 is a schematic top plan view of an alternate embodiment sideloader forklift vehicle of the present invention; and

FIG. 8 is a schematic side elevation view of the sideloader forklift vehicle shown in FIG. 7.

### DETAILED DESCRIPTION OF THE PREFERRED EMBODIMENTS

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

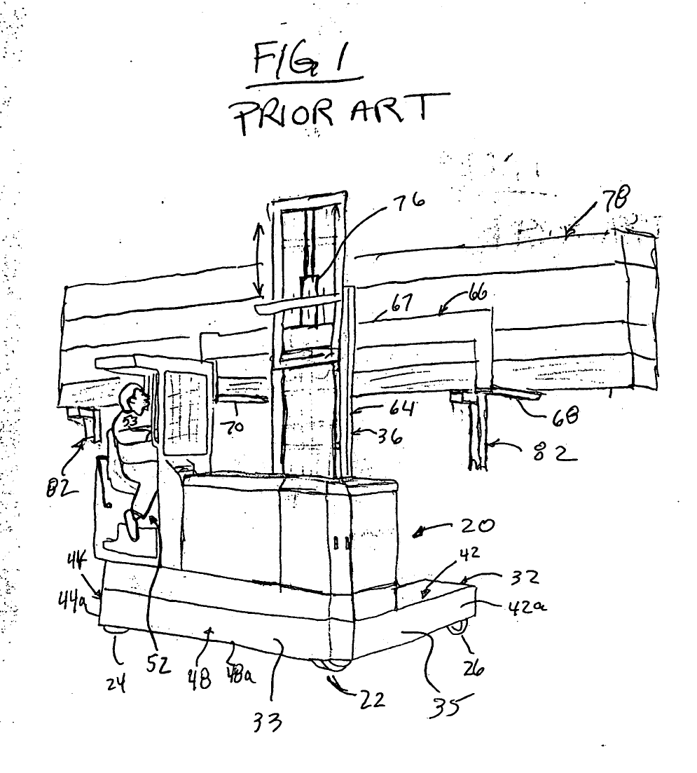

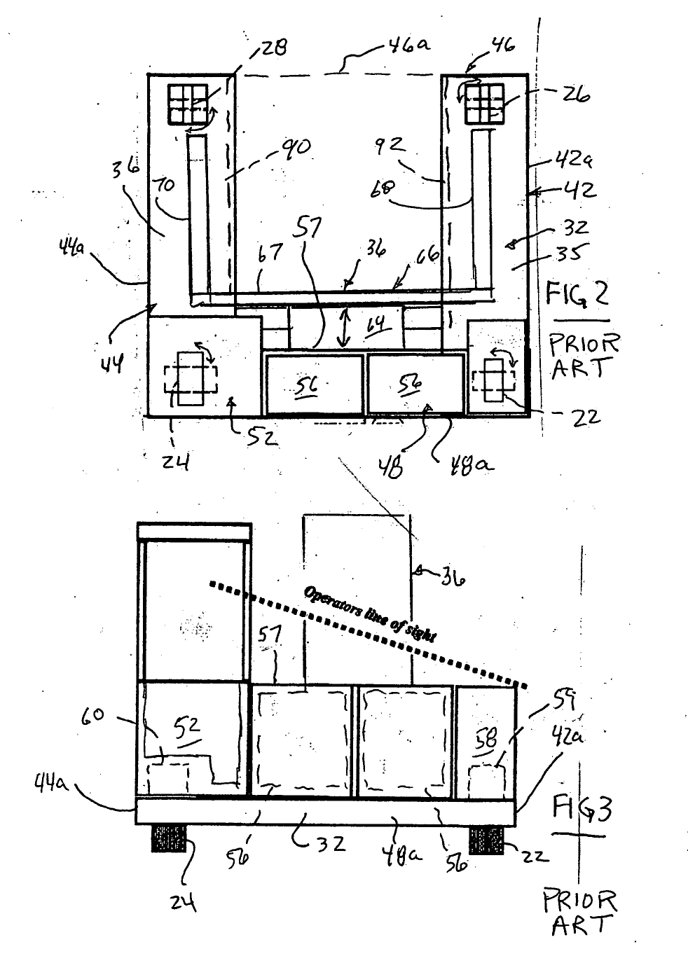

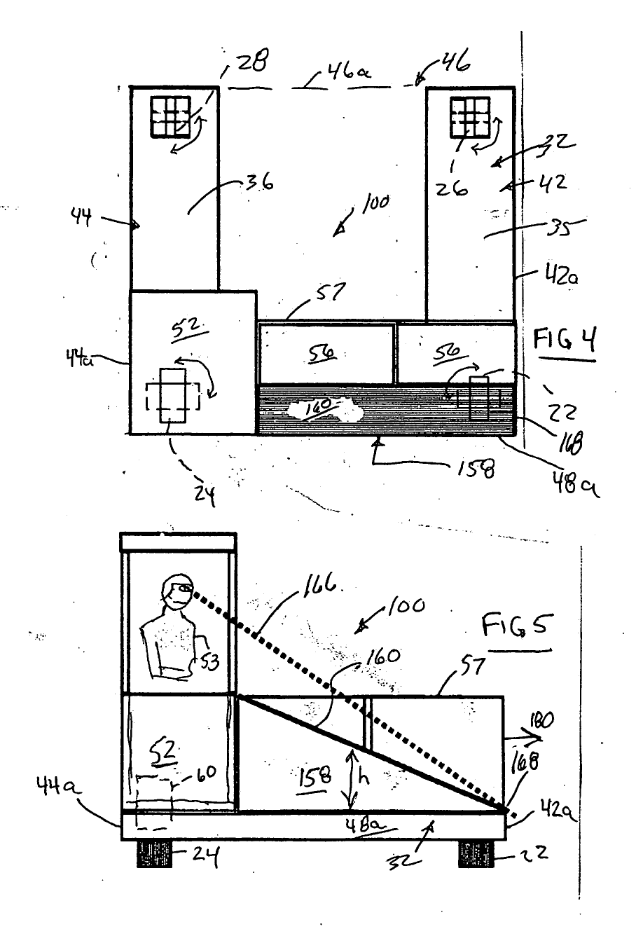

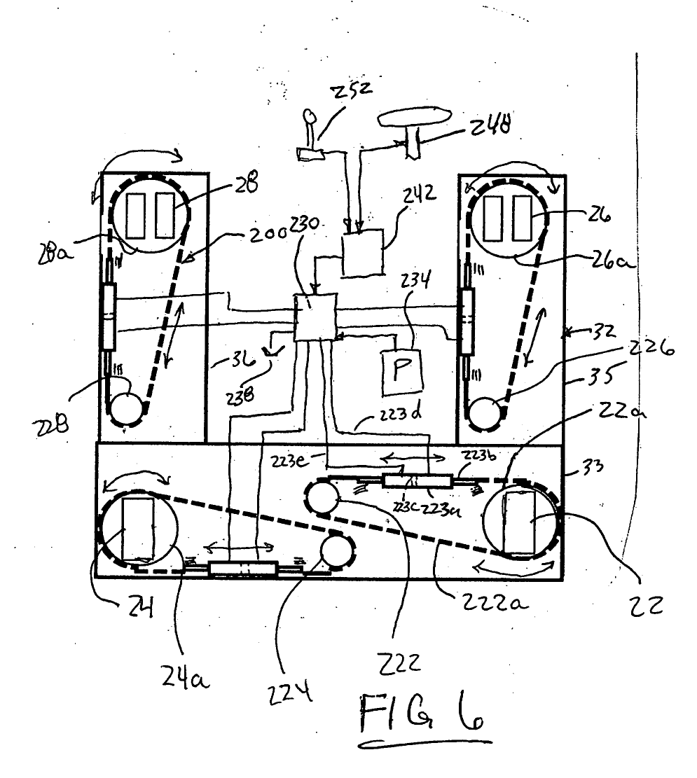

FIGS. 4 and 5 illustrate a sideloader forklift vehicle 100 of the present invention. Elements that are common to the prior art sideloader forklift vehicle described in FIGS. 1-3 carry identical reference numbers. The forklift assembly 36 is not shown in FIGS. 4 and 5 for simplicity but would be identical to that shown in FIGS. 1-3.

The sideloader forklift vehicle 100 includes batteries 56 that are arranged in the cabinet 57 set back from the chassis cab side edge 48a The end cabinet 58 shown in FIGS. 1-3 is replaced by a side cabinet 158 that is located adjacent to the edge 48a. The side cabinet 158 has a varying height “h” that is decreasing from the cab 52 toward the front end edge 42a.

According to the preferred embodiment, the height “h” decreases linearly, forming a tapered cabinet with a slanted cabinet top wall 160.

By tapering the cabinet 158 from the cab 52 to the front end edge 42a, the operator 53 has an unobstructed line of sight 166 to a top edge portion 168 of the front end edge 42a, without moving his head outside of the cab 52.

By observing this edge 168 that is close to the floor, the operator has a more accurate observation of the exact position of the chassis 32. By knowing the position of the chassis 32 and by observing, for example, pre-applied floor markings or other pre-existing structure on the cab side of the sideloader forklift vehicle, the operator can more accurately position the sideloader forklift vehicle on the rack side thereof.

Because the batteries 56 are relocated to a position that is between the rack side wheels 26, 28 and the cab side wheels 22, 24, a more stable sideloader forklift vehicle is achieved, that is less likely to tip during aggressive turning. Also, because the end cabinet 58 of FIGS. 1-3 is eliminated, the batteries 56 can be removed in a sliding fashion in the direction of the arrow 180. A door or removable panel can be provided in the cabinet 57 for battery removal. A lifting operation and the use of a crane to remove the batteries for replacement are avoided. Additionally, because of the replacement of the end cabinet 58 with the side cabinet 158, more plan area is available for the cab 52 to provide for operator comfort, i.e., a sitting cab with adequate legroom can be provided as opposed to a standing only cab arrangement.

The side cabinet 158 is configured to contain the hydraulic, electric components and electronic components to drive the forklift vehicle 100 and the forklift 36.

FIG. 6 illustrates a four-wheel steering system 200 according to another aspect of the invention. The steering system 200 is described in more detail in co-pending patent application U.S. Ser. No. ______, filed on the same day as the present application, naming the same inventor, and identified by attorney docket number 6681P0020US, and herein incorporated by reference.

The wheels 22, 24, 26, 28 can be driven, steerable wheels such as provided in the BAUMANN® Electric-Fourway-Sideloader Series EVU 20/25/30 available from Baumann Handling Systems, Inc., of Yorkville, Ill., USA or such as disclosed in U.S. Pat. Nos. 3,163,250; 3,698,504; 3,370,668; 4,461,367; 6,349,781; 6,367,571; or 6,854,552, all herein incorporated by reference.

The steering system 200 includes a drive sprocket 22a for turning the cab side driven wheel 22, a drive sprocket 24a for turning the cab side driven wheel 24, a drive sprocket 26a for turning the rack side wheel 26, and a drive sprocket 28a for turning the rack side wheel 28. An idler sprocket 222 is arranged spaced from the drive sprocket 22a. An idler sprocket 224 is arranged spaced from the drive sprocket 24a. An idler sprocket 226 is arranged spaced from the drive sprocket 26a. An idler sprocket 228 is arranged spaced from the drive sprocket 28a.

A drive chain 222a is wrapped around the drive sprocket 22a and the idler sprocket 222. A dual acting hydraulic cylinder 222b includes a cylinder portion 223a, a dual acting rod 223b that penetrates through the cylinder portion 223a and is connected at an intermediate position to a piston 223c within the cylinder portion 223a. The rod is exposed on opposite ends outside of the cylinder portion. The cylinder portion 223a is fastened to the drive chain 222a. The opposite ends of the rod 223b are fastened to stationary structure of the chassis 32. Hydraulic fluid communicates through hydraulic lines 223d, 223e into the cylinder portion 223a on opposite sides of the piston 223c. Depending on the differential pressure within the lines 223d, 223e, the cylinder portion 223a will slide along the rod 223b in a selected direction. Movement of the cylinder portion 223a will cause circulation of the drive chain 222a in a selected direction. Circulation of the drive chain 222a will then cause turning of the drive sprocket 22a and turning of the wheel 22.

Each of the other drive sprocket and idler sprocket pairs 24a, 224; 26a, 226; and 28a, 228 is wrapped by a respective drive chain and includes a hydraulic cylinder and an associated hydraulic circuit all arranged in the same configuration as that described above for the drive sprocket/idler sprocket pair 22, 222. Operation of the hydraulic cylinders for turning the respective wheel 24, 26, 28 is the same as that described for turning the wheel 22.

All of the hydraulic lines, such as 223d, 223e, are in fluid communication with a hydraulic valve network 230. The valve network can be a solenoid-controlled spool valve manifold that is electronically controlled. The valve network receives pressurized hydraulic fluid from a hydraulic pump 234 and is in selective fluid communication with a low pressure return line to a hydraulic reservoir 238.

The hydraulic valve network 230 is in signal-communication with an electronic controller 242. Electronic controller 242 receives as input signals the operator-selected traction direction, such as from a steering wheel 248 or like device and a direction selection lever 252.

The electronic controller is pre-programmed to convert the input signals to a corresponding output signal to the valve network to turn each of the four wheels 22, 24, 26, 28 to the correct angle. An example of a four-wheel steering control using an electronic controller controlling a hydraulic circuit to each wheel is described in U.S. Pat. No. 5,718,304 and is herein incorporated by reference.

According to one aspect of the present invention, the present inventor has recognized that a single motor 60 (FIG. 5) associated with drive wheel 24 is sufficient to drive the sideloader forklift vehicle under most circumstances. The further drive motor 59 can be eliminated while maintaining an effectively operable sideloader forklift vehicle. Therefore, the end cabinet 58 shown in prior art FIG. 3 that accommodated the further drive motor 59 can be eliminated as well. A more compact side loader forklift vehicle is possible with the unobstructed driver's sight line 166, given the relocation of the batteries 56 and the provision of the tapered side cabinet 158.

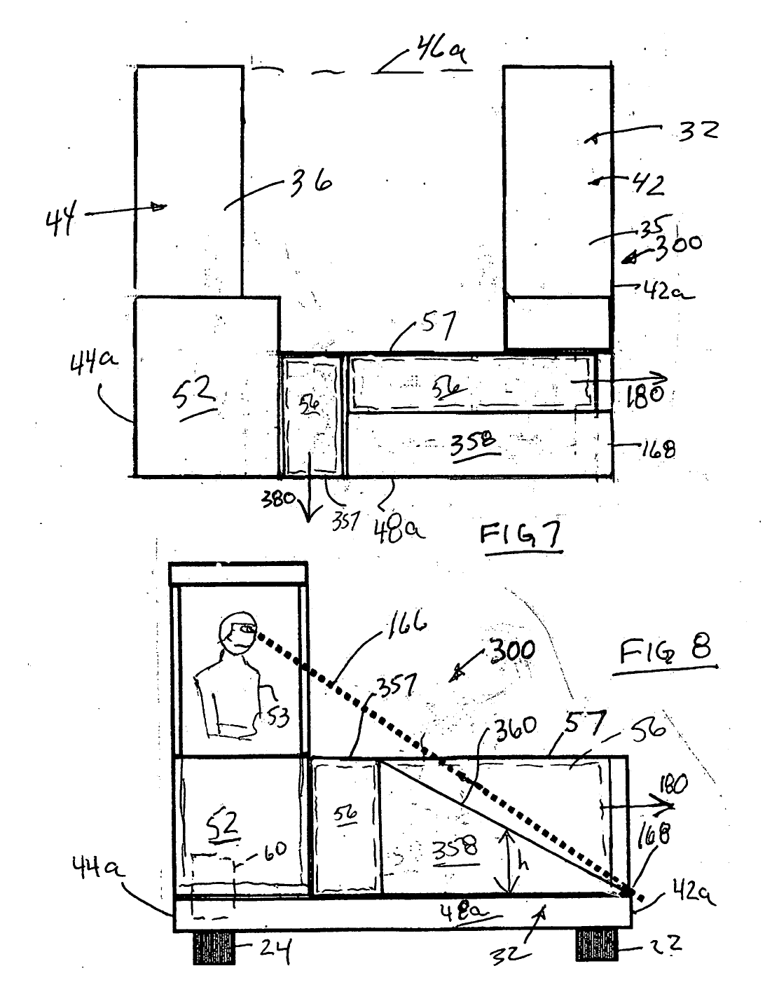

FIGS. 7 and 8 illustrate an alternate embodiment sideloader forklift vehicle 300 of the present invention. Elements that are common to the prior described sideloader forklift vehicles described in FIGS. 1-6 carry identical reference numbers. The forklift assembly 36 is not shown in FIGS. 7 and 8 for simplicity but would be identical to that shown in FIGS. 1-3.

The sideloader forklift vehicle 300 also includes batteries 56 that are arranged in the longitudinally extending cabinet 57 that is set back from the chassis cab side edge 48a. The end cabinet 58 shown in FIGS. 1-3 is replaced by a side cabinet 358 that is located along the edge 48a. Batteries 56 are also located within a laterally extended cabinet 357 that is adjacent the operator's cab 52 and along the edge 48a The side cabinet 358 has a varying height “h” that is decreasing from the cabinet 357 toward the front end edge 48a.

According to the preferred embodiment, the height “h” decreases linearly, forming a tapered cabinet with a slanted cabinet top wall 360.

By tapering the cabinet 358 from the cabinet 357 to the front edge 42a, the operator 53 has an unobstructed line of sight 166 to a top edge portion 168 of the front end edge 42a, without moving his head outside of the cab 52.

By observing this edge 168 that is close to the floor, the operator has a more accurate observation of the exact position of the chassis 32. By knowing the position of the chassis 32 and by observing, for example, pre-applied floor markings or other pre-existing structure on the cab side of the sideloader forklift vehicle, the operator can more accurately position the sideloader forklift vehicle on the rack side thereof.

Because the batteries 56 have an overall center of gravity that is relocated to a position that is between the rack side wheels 26, 28 and the cab side wheels 22, 24, a more stable sideloader forklift vehicle is achieved, that is less likely to tip during aggressive turning. Also, because the end cabinet 58 of FIGS. 1-3 is eliminated, the batteries 56 in the cabinet 57 can be removed in a sliding fashion in the direction of the arrow 180 and the batteries 56 that are located in the laterally extending cabinet 357 can be removed in a sliding fashion in the direction 380 (FIG. 7). A door or removable panel can be provided in the respective cabinets 57, 357 for battery removal. A lifting operation and the use of a crane to remove the batteries for replacement are avoided. Additionally, because of the replacement of the end cabinet 58 with the side cabinet 358, more plan area is available for the cab 52 to provide for operator comfort, i.e., a sitting cab with adequate legroom can be provided as opposed to a standing only cab arrangement.

The side cabinet 358 is configured to contain the hydraulic, electric components and electronic components to drive the forklift vehicle 300 and the forklift 36.

From the foregoing, it will be observed that numerous variations and modifications may be effected without departing from the spirit and scope of the invention. It is to be understood that no limitation with respect to the specific apparatus illustrated herein is intended or should be inferred.

The invention claimed is:

1. An electrically powered forklift vehicle, comprising:
a chassis defining a rack side edge, a cab side edge opposite to said rack side edge, a front end edge, and a rear end edge opposite to said front end edge;
a plurality of wheels supporting said chassis from a ground surface;
a forklift mechanism oriented to load and unload elongated articles across said rack side edge of said forklift vehicle;
an operator's cab located along said cab side edge and said rear end edge of said forklift vehicle;
at least one battery sized to power the movement of said forklift vehicle, said battery elongated along an arrangement line parallel to said cab side edge and having a cab side face located at a distance from said cab side edge whereby an operator within said operator's cab has a clear line of vision to a corner of said chassis defined by said cab side edge and said front end edge.

2. The forklift vehicle according to claim 1, comprising an equipment cabinet located between said cab side edge and said cab side face of said battery, said equipment cabinet having a tapered height toward said front end edge.

3. The forklift vehicle according to claim 2 wherein said equipment cabinet extends from said operator's cab to said front end edge, said height of said equipment cabinet being linearly tapered from said operator's cab to said front end edge.

4. The forklift vehicle according to claim 3 wherein said at least one battery comprises two rectangular batteries arranged side to side and along said arrangement line.

5. The forklift vehicle according to claim 4 wherein said to batteries extend along said arrangement line from said operator's cab to said front end edge.

6. The forklift vehicle according to claim 5 wherein said equipment cabinet houses electronic and hydraulic components of said apparatus.

7. The forklift vehicle according to claim 1 comprising one electric drive motor driving one of said plurality of wheels.

8. The forklift vehicle according to claim 7 comprising a steering drive operatively connected to each wheel of said plurality of wheels.

9. The forklift vehicle according to claim 8 wherein said plurality of wheels comprises four wheels.

10. A forklift vehicle, comprising:
a chassis defining a rack side edge, a cab side edge opposite to said rack side edge, a front end edge, and a rear end edge opposite to said front end edge;
a plurality of wheels supporting said chassis from a ground surface;
a forklift mechanism oriented to load and unload elongated articles across said rack side edge of said forklift vehicle;
an operator's cab located along said cab side edge and said rear end edge of said forklift vehicle;
comprising an equipment cabinet located along said cab side edge, said equipment cabinet having a tapered height toward said front end edge, whereby an operator within said operator's cab has a clear line of vision to a corner of said chassis defined by said cab side edge and said front end edge.

11. The forklift vehicle according to claim 10, wherein said chassis comprises a U-shape with an open side of said U-shape along said rack side edge, and said plurality of wheels comprise four wheels arranged in a rectangular pattern, and comprising a plurality of batteries arranged side by side along said equipment cabinet, spaced from said cab edge.

12. The forklift vehicle according to claim 11 wherein said equipment cabinet extends from said operator's cab to said front end edge, said height of said equipment cabinet being linearly tapered from said operator's cab to said front end edge.

13. The forklift vehicle according to claim 12 wherein said operator's cab comprises a seat and sufficient legroom for the operator to sit during operation.

14. The forklift vehicle according to claim 13 wherein said equipment cabinet houses electronic and hydraulic components of the apparatus.

15. The forklift vehicle according to claim 10 comprising only one electric drive motor driving one of said plurality of wheels.

16. The forklift vehicle according to claim 15 comprising a steering drive operatively connected to each wheel of said plurality of wheels.

17. The forklift vehicle according to claim 16 wherein said plurality of wheels comprises four wheels.
